(19) United States
(12) Patent Application Publication
(10) Pub. No.: US 2014/0049489 A1
(43) Pub. Date: Feb. 20, 2014

(54) ELECTRONIC DEVICE AND METHOD FOR DISPLAYING ICON

(71) Applicant: HON HAI PRECISION INDUSTRY CO., LTD., New Taipei (TW)

(72) Inventor: HONG-SHENG CHEN, New Taipei (TW)

(21) Appl. No.: 13/941,569

(22) Filed: Jul. 15, 2013

(30) Foreign Application Priority Data
Aug. 16, 2012 (TW) 101129739

(51) Int. Cl. G06F 3/0488

(52) U.S. Cl. CPC G06F 3/04886
USPC 345/173

(57) ABSTRACT

An electronic device capable of being controlled by a remote device can present a display of relevant buttons. Each button on the remote device has at least one characteristic of appearance, and at least one function. The electronic device includes a displaying unit, a storing unit and a controlling unit. The storing unit stores at least one characteristic of appearance (first feature) and at least one button function (second feature). A controlling unit obtains the first and second features, and controls the displaying unit to display the first and second features together as a generated icon corresponding to the one of the buttons on the remote device. A method for displaying such icons is also provided.

### BACKGROUND

1. Technical Field

The present disclosure relates to an electronic device; and particularly to an electronic device capable of displaying icon for button, and a method for displaying icon for button.

2. Description of Related Art

A remote control for an electronic device may include a number of function buttons for controlling the electronic device, each function button corresponds to a specific function of the electronic device. The electronic device often displays explanatory notes corresponding to each function icon for a button, for guiding users to operate the remote control. For example, as that shown in FIG. 5 in a related art, each icon 40 represents a function button, and the text corresponding to the function button 40 is displayed apart from and adjacent to the icon 40, as a result, space occupied by the icons and explanatory notes takes up valuable real estate on the display.

Therefore, there is room for improvement in the art.

### BRIEF DESCRIPTION OF THE DRAWINGS

Many aspects of the embodiments can be better understood with reference to the following drawings. The components in the drawings are not necessarily drawn to scale, the emphasis instead being placed upon clearly illustrating the principles of the embodiments. Moreover, in the drawings, like reference numerals designate corresponding parts throughout the five views.

FIG. 1 is a block diagram of an electronic device with a remote device having a plurality of buttons in accordance with an embodiment.

FIG. 2 is a partial enlarged view of the remote device in FIG. 2.

FIG. 3 is a perspective view showing an electronic device displaying icons for button in FIG. 2.

FIG. 4 is a flowchart of a method for displaying icon in accordance with an embodiment.

FIG. 5 is a perspective view showing an electronic device of a related art displaying icons with explanatory notes.

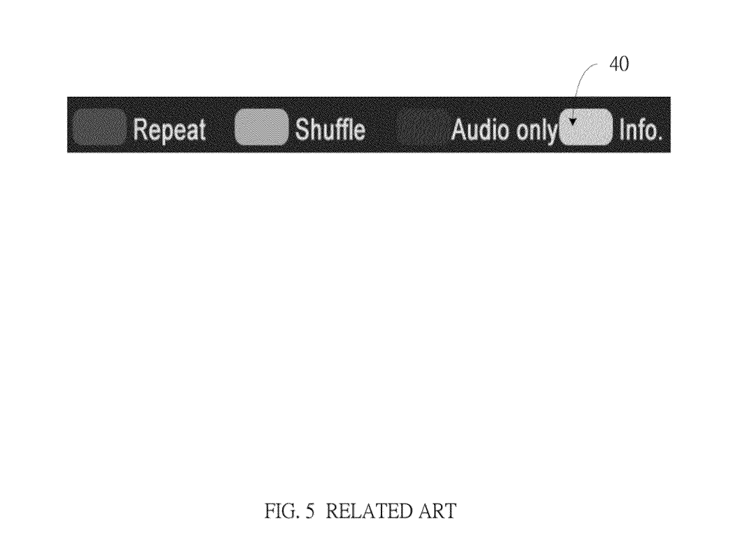

### DETAILED DESCRIPTION

The disclosure is illustrated by way of example and not by way of limitation in the figures of the accompanying drawings in which like references indicate similar elements. It should be noted that references to “an” or “one” embodiment in this disclosure are not necessarily to the same embodiment, and such references mean “at least one.”

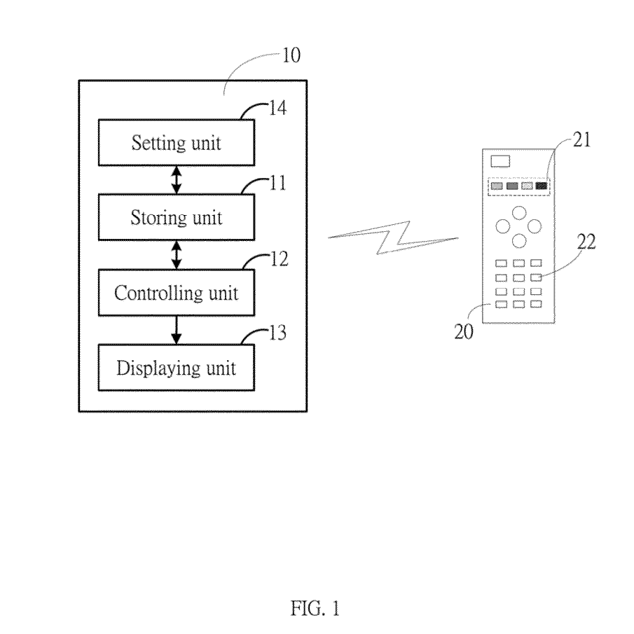

Referring to FIG. 1, a control device 20 for an electronic device 10 is provided. In the embodiment, the electronic device 10 is a television, and the control device 20 is a remote control device.

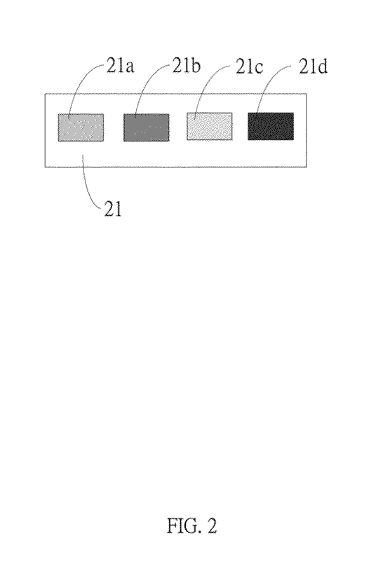

The control device 20 includes a specific button area 21 and a number of ordinary buttons 22. The ordinary button 22 is used for controlling the electronic device 10 to perform functions, for example, to select a channel or to adjust the volume. Referring also to FIG. 2, in this embodiment, a repeat button 21a, a shuffle button 21b, an audio-only button 21c and an information button 21d are mounted on the button area 21, for example. The repeat button 21a is used for controlling the electronic device 10 to enter a repeat-play mode. The shuffle button 21b is used for controlling the electronic device 10 to enter a random play mode. The audio-only button 21c is used for controlling the electronic device 10 to enter an audio-only play mode. The information button 21 d is used for controlling the electronic device 10 to show more detailed information about the electronic device 10. The buttons 21a, 21b, 21c, and 21d have at least one characteristic, for example color, shape, or pattern, for distinguishing each one from the others. In this embodiment, the distinguishing characteristic is color.

Referring again to FIG. 1, the electronic device 10 includes a storage unit 11, a controlling unit 12, a displaying unit 13, and a setting unit 14. The storage unit 11 is used for storing at least one first feature and at least one second feature, and the first feature is different from the at least one second feature. In detail, each first feature indicates the characteristics of one button mounted on the button area 21, for example, a color of the button, a shape of the button, a pattern of the button, and the like. The second feature indicates a function of the button mounted on the button area 21.

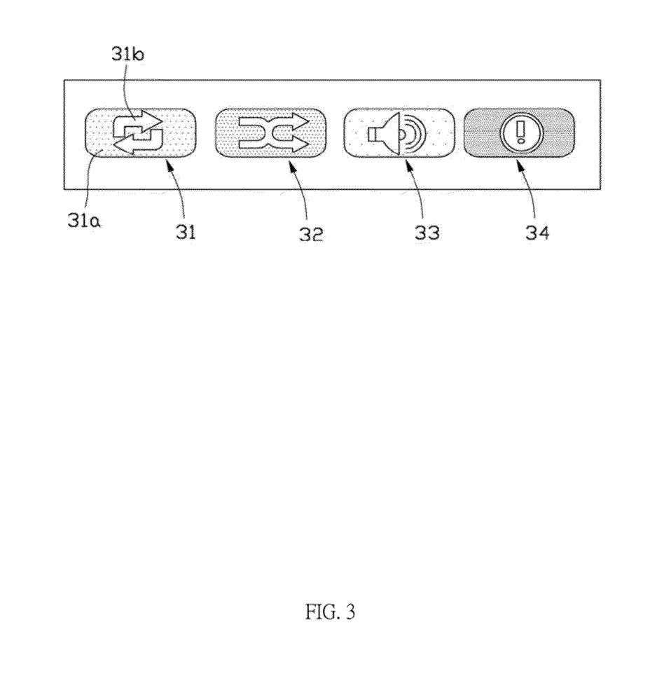

The controlling unit 12 obtains the first and second features from the storage unit 11, and controls the displaying unit 14 to display the selected first and second features together, to generate a icon for button. The icon corresponds to one of the buttons mounted on the button area 21, such that the relationship between the displayed icon and the button mounted on the button area 21 can be recognized by the user. Referring to FIG. 3, in the embodiment, the controlling unit 12 generates a icon 31 corresponding to the button 21a, a icon 32 corresponding to the button 21b, a icon 33 corresponding to the button 21c and a icon 34 corresponding to the button 21d. For example, with respect to the icon 31, the second feature (e.g., a repeat-play icon) which is labeled as 31b and the first feature (e.g., a colored rectangle) which is labeled as 31a are laid such that one superposed the other. Thus, the user knows that the icon 31 corresponds to the repeat button 21a according to the color of the icon 31, which is the same to the color of the repeat-play button 21 a, and further knows the function of the icon 31 as the repeat-play icon, such that when the user presses the repeat-play button 21a, the electronic device 10 enters the repeat-play mode.

The controlling unit 12 is further used for controlling the displaying unit 13 to display detailed information of the button mounted on the button area 21 in response to a query by the user. In the embodiment, the detailed information is a detailed description of the button mounted on the button area 21, and floats on the current user interface in the form of a balloon or other shape. The detailed information may be explanatory notes about the second feature. Thus, the user can acquire more knowledge about the functions of the buttons.

The setting unit 14 is used for adjusting the second feature of the icon, for changing the function description of the icon. When the function of one button is changed to another function, the setting unit 14 changes the second feature of a icon to illustrate the new function of the icon. In other words, the second feature of the icon is updated when the function of the button has been changed. In the embodiment, the second feature can be changed according to an operation of the control device 20 when required by user. In another embodiment, the second feature can be changed according to a third party software. For example, when the third party software is a music player software, the setting unit 14 changes the second feature according to a shortcut provided by the third party software. The default feature setting of the icon is set by the manufacturer when the electronic device 10 is shipped out of factory.

The electronic device 10 includes a number of working modes, such as main menu display mode and music play mode. Each working mode has a corresponding user interface. The controlling unit 12 controls the displaying unit 13 to display the icons in an appropriate position on each user interface, at the user's convenience. For example, when the electronic device 10 is in the main menu display mode, the icons are shown in the lower part of the user interface. When the electronic device 10 is in the music play mode, the icons are shown in the music playback window of user interface.

In other embodiments, the electronic device 10 may be set-top box or DVD player, or the like. The displaying unit 13 may be an independent display electrically connected to the electronic device 10. The control device 20 may be a physical keyboard, a virtual keyboard which is displayed in the display of the electronic device 10, or a line control.

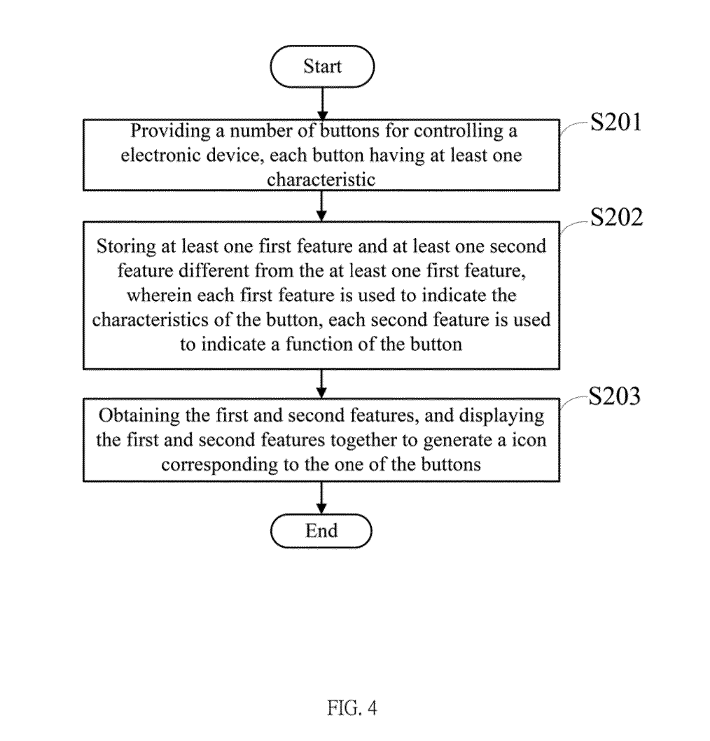

Referring to FIG. 4, a method for displaying icon is implemented by an electronic device 10.

In step S201, the control device 20 provides a number of buttons mounted on the button area 21, and each of the buttons has at least one characteristic, for example color, shape, or pattern, for distinguishing each one from the other. In this embodiment, the feature is color.

In step S202, the electronic device 10 stores at least one first feature and at least one second feature, and the first feature is different from the at least second feature. In detail, each first feature indicates a characteristic of one button mounted on the button area 21, for example, a color of the button, a shape of the button, a pattern of the button, and the like. The second feature indicates a function of the button mounted on the button area 21.

In step S203, the controlling unit 12 obtains the first and second features from the storage unit 11, and displays the selected first and second features together, to generate a icon for button. The icon corresponds to one of the at least one buttons, such that the relationship between a displayed icon and the button mounted on the button area 21 can be recognized by the user.

Using the above described electronic device 10 and method for displaying icons, the first feature for distinguishing the buttons from each other and the second feature for illustrating the specific function of each button are included and shown in one icon, thus user can apply the function each button according to one icon, and the space occupied by button descriptions or titles can be reduced. Further more, the icon also can be applied in different user interfaces, the flexibility of the icon is also improved.

It is to be understood, that even though information and advantages of the present embodiments have been set forth in the foregoing description, together with details of the structures and functions of the present embodiments, the disclosure is illustrative only; and changes may be made in detail, especially in the matters of shape, size, and arrangement of parts within the principles of the present embodiments to the full extent indicated by the broad general meaning of the terms in which the appended claims are expressed.

What is claimed is:

1. An electronic device comprising:
a displaying unit;
a storage unit storing at least one first feature and at least one second feature different from the at least one first feature, wherein each first feature is used to indicate one characteristic of one of buttons<<Can we positively claim the buttons/icons>> for controlling the electronic device, each second feature is used for illustrating a function of the one of the buttons; and
a controlling unit to obtain the first and second feature, and control the displaying unit to display the first and second features together to generate a icon corresponding to the one of the buttons.

2. The electronic device according to claim 1, wherein the characteristic of one of buttons comprises color, shape, and pattern.

3. The electronic device according to claim 1, further comprising a setting unit for adjusting the second feature of the icon for changing function description of the button.

4. The electronic device according to claim 1, wherein the controlling unit further control the displaying unit to display detailed information of the button in response to users' operations.

5. The electronic device according to claim 4, wherein the detailed information is explanatory note corresponding to each button.

6. The electronic device according to claim 1, wherein the buttons are on a remote control of the electronic device.

7. A method for displaying icon for an electronic device, the method comprising:
providing a plurality of buttons for controlling the electronic device, each button having at least one characteristic;
storing at least one first feature and at least one second feature different from the at least one first feature, wherein each first feature is used to indicate the characteristics of the button, each second feature is used to indicate a function of the button; and
obtaining the first and second features and displaying the first and second features together to generate a icon corresponding to the one of the buttons.

8. The method for displaying icon according to claim 9, wherein the characteristics of one of the buttons comprises color, shape, and pattern.
